(19) United States
(12) Patent Application Publication
(10) Pub. No.: US 2009/0158180 A1
(43) Pub. Date: Jun. 18, 2009

(54) SYSTEM AND METHOD OF STYLING AN EMBEDDED WIDGET

(75) Inventors: Joseph Andrew Magnani, San Francisco, CA (US); Steven Horowitz, Oakland, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/958,283

(22) Filed: Dec. 17, 2007

(51) Int. Cl. G06F 3/048

(52) U.S. Cl. 715/764

(57) ABSTRACT

An inline-customizable widget receives an indication from a user that he would like to customize the widget, offers the user various customization options, and ultimately provides the user with a customized widget (per the user's settings) to be embedded in a web page of the user's choice, as facilitated by the widget itself; every step in the customization process takes place within the widget itself and the user need not edit any widget code or visit any web page separate from the web page in which the widget is originally found.

### BACKGROUND

1. Field of the Invention

Aspects of the present invention relate generally to the styling of web-based widgets, and more specifically to widgets that can accept and respond to customization settings from within the widgets themselves, and can facilitate the embedding of the widgets, as customized, in other web pages.

2. Description of Related Art

As is known in the art, web-based widgets (also known as gadgets, badges, or modules, among other names familiar to those skilled in the art) enable end users to embed various third-party functionality into web pages. Widgets may be used to display various information, including weather forecasts for particular cities, current stock price of a certain company, news in a particular geographical area, news related to a particular topic, games, and the like. The inclusion of a widget in a web page can be accomplished through JavaScript™, an EMBED element, an embedded Flash® object, or other methods which bring the widget code into the web page, where the widget runs locally within a user's browser. While the widget code can consist entirely of Hypertext Markup Language (HTML), widgets also may be developed in either JavaScript™ or Adobe® Flash®.

Third-parties have generally offered widgets either in a single size or in a small number of varying sizes, sometimes with varying levels of functionality. For example, Yahoo!™ Finance offers a customizable widget for displaying financial information, which can include quotes, charts, and news, and in various combinations as decided by the user. After choosing which information he wants the widget to display, the user must then specify various other elements, such as the number of news headlines to display, which stock symbols to follow, and finally the width [and sometimes the height] of the module.

Traditionally, widgets that allow for some form of customization generally require the user to go to a separate web page (i.e., separate from where the widget was found) filled with forms (or similar) for specifying what the user wants the widget to include, look like, etc.

Thus, it would be desirable to package the customization options into the widget itself, such that a user can style the widget in real-time as he happens upon it embedded in a web page.

### SUMMARY

In light of the foregoing, it is a general object of the present invention to allow for the customization of a widget from within the widget itself, and to facilitate the placement of the widget, as customized, on a web page other than the one on which it was found.

### BRIEF DESCRIPTION OF THE DRAWING FIGURES

FIG. 1 is a simplified block diagram illustrating how the invention may be employed in accordance with the detailed description.

FIG. 2 illustrates generally the current methodology used to style a widget.

FIG. 3 is a logical flowchart of the general process by which widgets may be styled in accordance with the detailed description.

FIGS. 4A-4C illustrate an exemplary embodiment of the present invention.

### DETAILED DESCRIPTION

Detailed descriptions of one or more embodiments of the invention follow, examples of which may be graphically illustrated in the drawings. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of packaging within a widget the logic and resources needed to style the widget, in real-time, where it is accessed, and facilitating the inclusion of the widget in another web page.

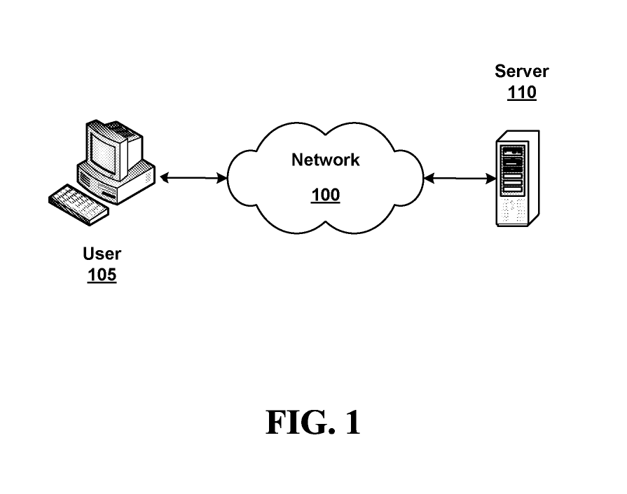

FIG. 1 is a simplified block diagram illustrating how the invention may be employed. Similar to other web-based widgets, a widget as defined herein may be embedded in a web page (as discussed herein) where it may be accessed by user 105 through a web browser; the widget may receive, over a network 100 (e.g., the Internet), and from server 110, the information it is to display (e.g., stock quotes, weather information, etc.).

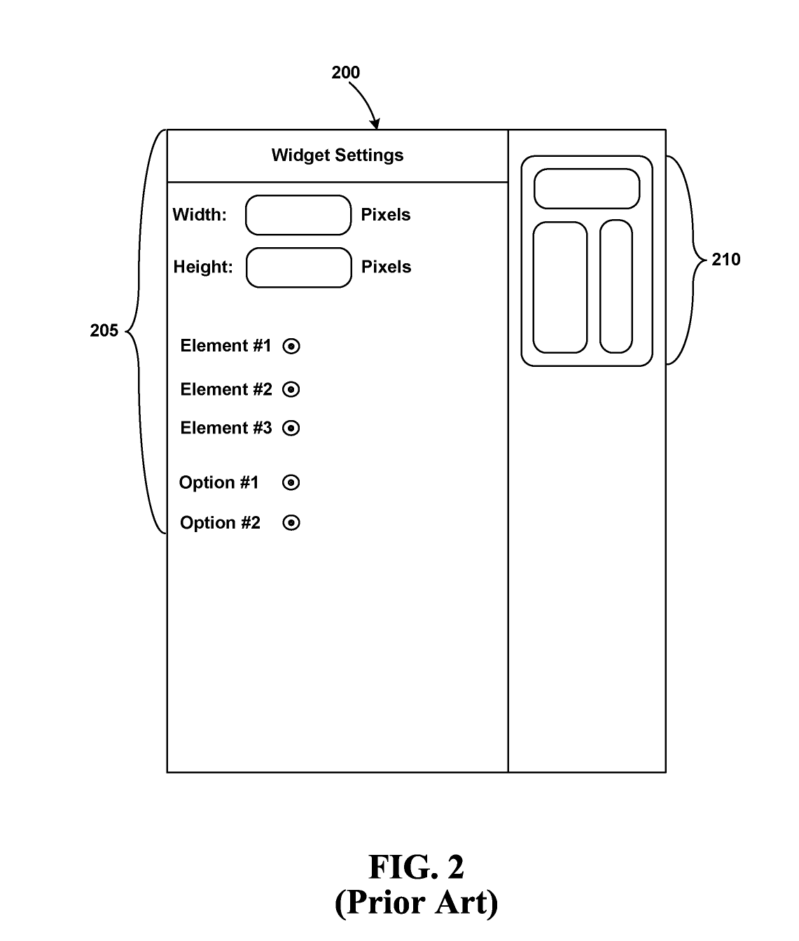

FIG. 2 illustrates a conventional process by which widgets are customized. There are a number of different ways a user may come across a widget he would like to use, including perusing a site that offers many and various widgets, or seeing a particular widget on another page, etc. Once a user has found a widget he likes, he will generally want to customize it in some manner (e.g., if the widget reports stock quotes, the user may want to define which companies' information to display, etc.). Heretofore, the customization process has generally required the user to visit a web page, not unlike customization page 200. Usually, customization page 200 includes various widget options 205 that may be defined by the user. Such options may include variables like height and width, and various other things such as whether to include certain widget elements in the widget (e.g., a stock widget may provide an element for displaying a graph of a certain stock's performance over the past year), etc. Customization page 200 may also include widget preview 210 so that the user may see what the widget will look like with his given settings (i.e., the options as the user defines them). Generally, after a user has defined the options the way he wants, he will be presented with yet another page that includes the code he will use to embed the now-customized widget into the web page/site of his choice.

In some cases, the user may actually be required to modify the embed code himself; the widget may have no GUI front-end for its customization and so the user may have to edit the embed code and use a kind of trial-and-error approach to get the widget to look/behave the way he wants. If the user does not have much experience modifying such code, he may find himself unable to customize the widget.

In contrast, the invention—an inline-customizable widget—allows the user to define the widget options from within the widget itself, and without having to edit code. Revisiting the previous examples, the user may come upon an inline-customizable widget he likes in a number of different ways, but instead of being made to search for the widget and then customize it through various pages not necessarily related to the widget's instantiation (if customization is available at all), the user may customize the widget directly from where it was found, and then “export” the customized widget to a web page of his choice. For example, if a user comes across a web page with a widget that he likes, an inline-customizable widget may provide a “button” (e.g., a hypertext link, etc.) through which the user can alert the widget that he would like to begin customizing it (i.e., that he will customize the widget he is currently viewing).

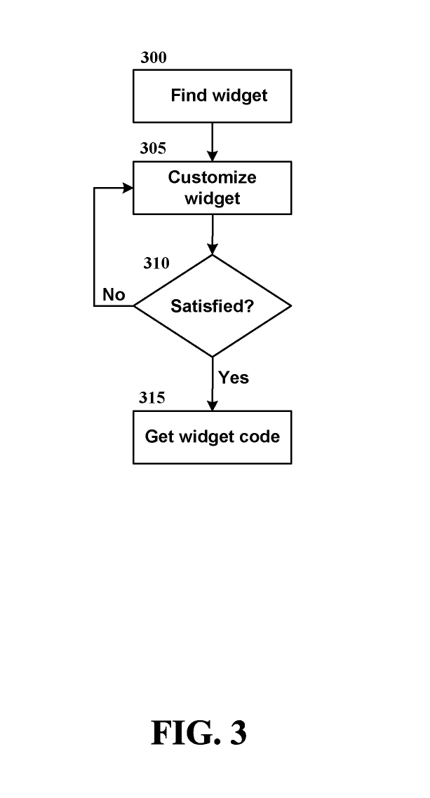

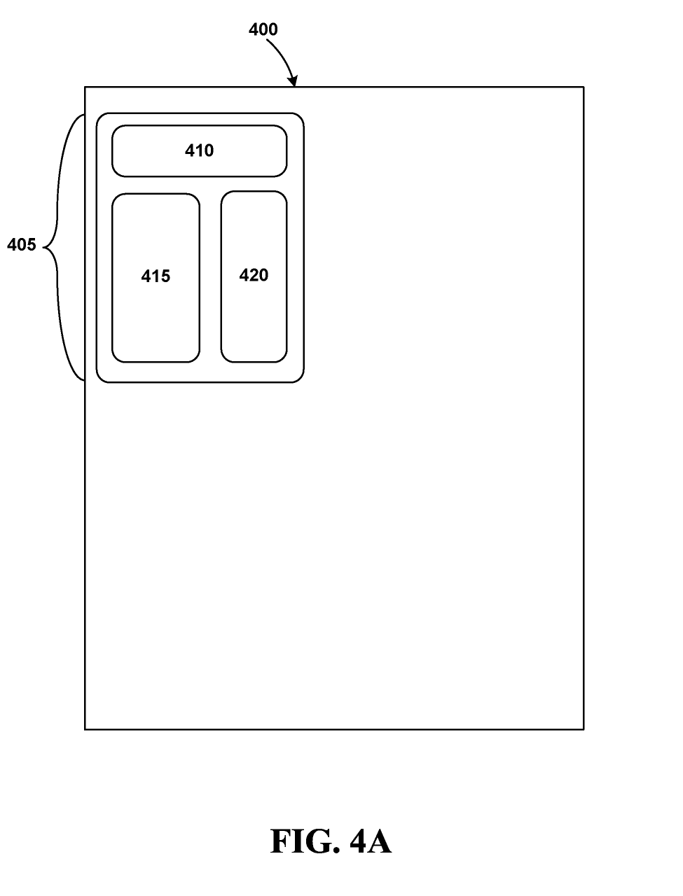

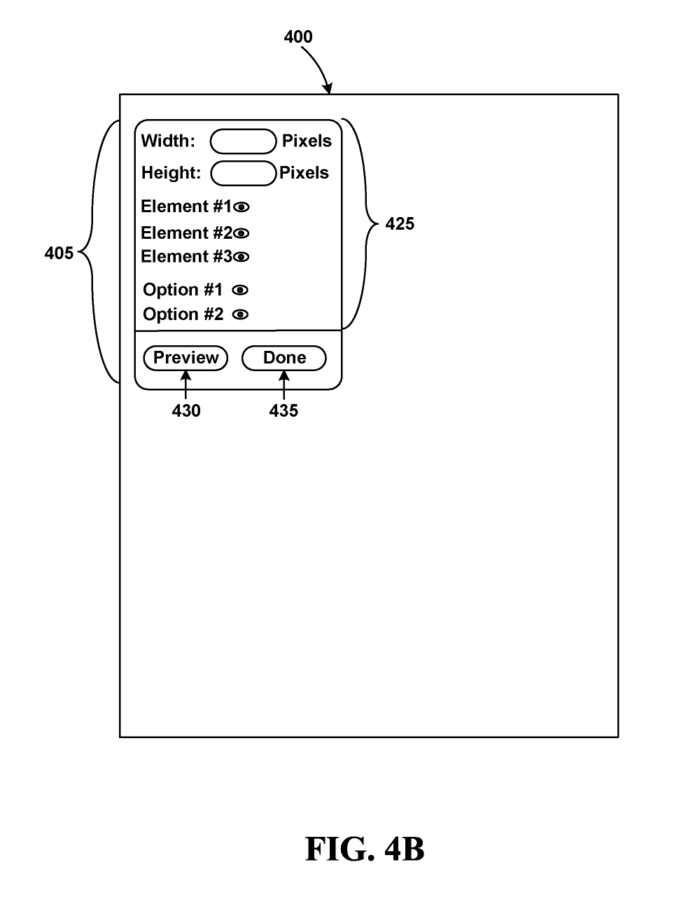

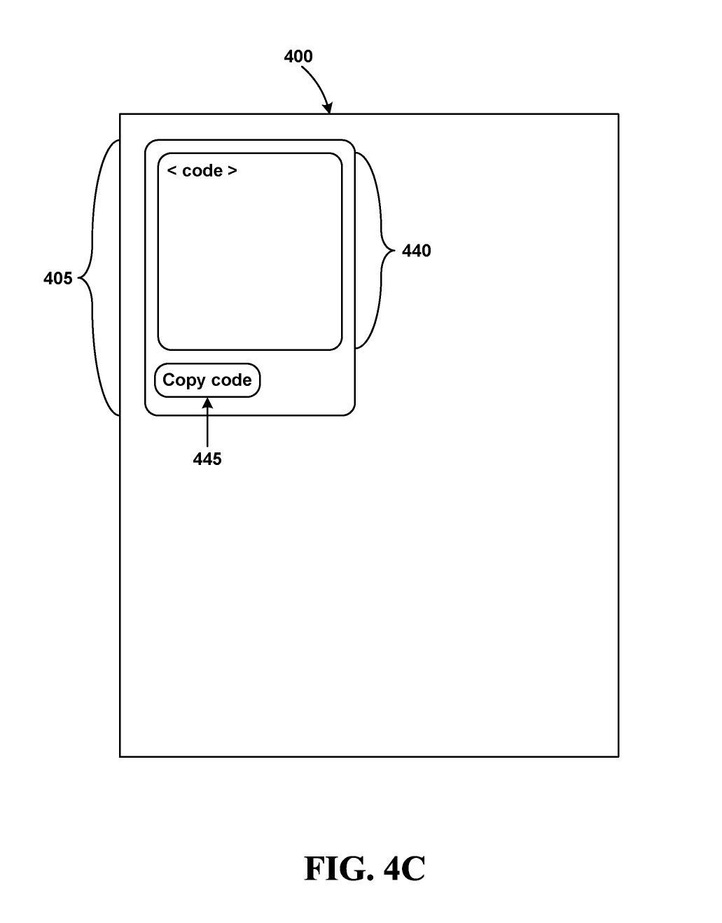

FIG. 3 is a flowchart illustrating interaction with widgets according to the present invention, and FIGS. 4A-4C illustrate an exemplary embodiment of the present invention; both figures will be referenced together for the remainder of the discussion below.

As illustrated at block 300, a user comes across inline-customizable widget 405 embedded within web page 400 (see FIG. 4A). As discussed above, the user may come across widget 405 while browsing the web, browsing a particular site dedicated to making widgets available for download, or the like. Widget 405 may comprise any of a number of widget elements 410, 415, and 420, which display information, control some aspect of the widget, etc. Widget 405 may have some text or an image or some other way to signal to a user that the widget is customizable; the user may then take some action (e.g., click on the text, etc.) and begin the customization process, as illustrated at blocks 305 and 310.

Unlike other widget customization schemes, the user is not transferred to another page for customization, or given the embed code and told to edit it to his liking; instead, widget 405 becomes the customization “page,” as illustrated in FIG. 4B. The logic and code needed for the widget's customization is built into the widget itself. This scheme not only allows for a user's immediate gratification (e.g. by not requiring the user to go to some other site to begin the customization process and/or modify any code), but also reduces the number of interfaces the widget producer has to create and maintain because the customization process is built into the widget itself. For example, and as previously explained, widgets generally require the user to use a separate web page for their customization, and these web pages must be maintained by someone (e.g., the widget producer, etc.); an inline-customizable widget eliminates the additional web page element, and so the widget producer can concentrate on only the widget itself. Moreover, the user's entire experience is simplified, which may facilitate increased adoption and use of the widget.

FIG. 4B is a snapshot of a possible customization process, as built into widget 405. For exemplification purposes only, customization options 425 are similar to those found in FIG. 2. It will be appreciated by those of skill in the art that customization options 425 may vary to differing degrees from those shown and will depend largely on the widget's purpose and function. For example, a widget for displaying the most recent news items from a particular source would have different customization options (e.g., how many news items to display, etc.) than would a widget used to display the weather in particular cities (e.g., which cities, etc.). Customization options 425 may be displayed inside the original boundaries of widget 405 (i.e., the footprint widget 425 had when the user originally started interacting with it); however, if there are more options than can be displayed at once, and within the confines of the widget, the widget can be made to accommodate this in a number of ways. For example, the widget may be programmed to resize itself so that all options can fit, or the options may be “flipped” through (i.e., after the initial options are set, the user can choose to see more options, etc.), or the options may be scrolled through within the widget, etc. It will be understood by those of skill in the art that the automatic resizing of the widget may be limited by the markup surrounding it and controlling its presentation.

It may be the case that widget 405 contains various “buttons” for signaling to the widget that the user would like to preview the widget with the just-defined options, that he is done with the customization phase, etc. For example, widget 405 contains “buttons” 430 and 435 for previewing the widget and alerting the widget that the user is done customizing it. Depending on the widget producer's preference, it may be the case that the widget is automatically previewed after each option is changed, instead of requiring the user to explicitly tell the widget to remove the customization options and show the ‘new’ widget.

Once the user is satisfied that the widget looks and acts the way he wants, he may signal to the widget that he is done and for the widget to reveal the code needed for the widget's use, as illustrated at block 315 and by “button” 435. In one embodiment, widget 405 may then display the required code 440 within the widget itself, as shown in FIG. 4C. Similar to the widget code provided by the usual widget customization pages, code 440 may be plain ASCII text to be copied and pasted into the source code of the user's web page. Widget 405 may include a “button” 445 that, when pressed, copies code 440 to the clipboard of the user's operating system. In either case, the widget may revert back to the original state in which the user found it (e.g., by clicking on another “button” used for this purpose; or, where the code is automatically copied to the clipboard, automatically reverting to the original state after the code has been placed on the clipboard, etc.).

In another embodiment, widget 405 may be able to “talk” directly with various online entities (e.g., My Yahoo!™, MySpace™, Facebook™, etc.) through, for example, an Application Programming Interface (API). In such an implementation, the user may simply choose (through various “buttons,” drop-downs, etc.) to which site(s) he would like the widget installed. The widget may include further customization options depending on the site/service to which it will be added (as chosen by the user). For example, after completing the customization of a widget, the user may wish to add the widget to his My Yahoo!™ “homepage,” which may allow the user to specify, for example, on which side of the page the widget should be installed, etc. These site-specific options may appear only after the user has decided on a specific site/service on which he would like the widget to persist.

The sequence and numbering of blocks depicted in FIG. 3 is not intended to imply an order of operations to the exclusion of other possibilities. Those of skill in the art will appreciate that the foregoing systems and methods are susceptible of various modifications and alterations. For example, the widget may not allow the user to embed the widget in a web page of his choosing, but instead may require the user to choose one of various site/services in which it may be embedded; in such a case, block 315 would not be needed.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of customizing a widget embedded within a first web page, and facilitating the placement of the widget, as customized, on a second web page, said method comprising:
in response to a request to customize the widget, offering, only within the widget itself, a plurality of options for customizing the widget;
accepting settings associated with the plurality of offered options;
responsive to the accepted settings, customizing the widget; and
facilitating, within the widget itself, the placement of the customized widget on the second web page.

2. The method of claim 1 wherein said facilitating is in the form of code to be embedded in the second web page.

3. The method of claim 1 wherein the offered options comprise a plurality of sites or services into which the customized widget may be embedded.

4. The method of claim 3 wherein said facilitating further comprises embedding the widget into one of the plurality of offered sites or services.

5. The method of claim 1 further comprising displaying a real-time preview of the widget in response to said accepting.

6. The method of claim 1 further comprising displaying a real-time preview of the widget in response to a request for the real-time preview.

7. A computer-readable medium encoded with a computer-executable program to perform a method of customizing a widget embedded within a first web page, and facilitating the placement of the widget, as customized, on a second web page, said method comprising:
in response to a request to customize the widget, offering, only within the widget itself, a plurality of options for customizing the widget;
accepting settings associated with the plurality of offered options;
responsive to the accepted settings, customizing the widget; and
facilitating, within the widget itself, the placement of the customized widget on the second web page.

8. The computer-readable medium of claim 7 wherein said facilitating is in the form of code to be embedded in the second web page.

9. The computer-readable medium of claim 7 wherein the offered options comprise a plurality of sites or services into which the customized widget may be embedded.

10. The computer-readable medium of claim 9 wherein said facilitating further comprises embedding the widget into one of the plurality of offered sites or services.

11. The computer-readable medium of claim 7 further comprising displaying a real-time preview of the widget in response to said accepting.

12. The computer-readable medium of claim 7 further comprising displaying a real-time preview of the widget in response to a request for the real-time preview.
